(19) United States
(12) Patent Application Publication
(10) Pub. No.: US 2012/0160943 A1
(43) Pub. Date: Jun. 28, 2012

(54) BEVERAGE-MAKING METHOD

(75) Inventor: Alessandro Magno, Brembate Sopra (IT)

(73) Assignee: N&W GLOBAL VENDING S.P.A., Valbrembo (IT)

(21) Appl. No.: 13/266,689

(22) PCT Filed: Apr. 27, 2010
(86) PCT No.: PCT/IB10/00933

§ 371 Date: Feb. 7, 2012

(30) Foreign Application Priority Data
Apr. 28, 2009 (IT) TO2009A000335

(51) Int. Cl. B02B 5/02

(52) U.S. Cl. 241/25

(57) ABSTRACT

In a brewing assembly—wherein a brewing chamber has an inlet facing the outlet of a funnel of a grinding device having two grinding units, each of which can be activated selectively to dispense a powder to the brewing chamber through a respective active portion of the outlet—the brewing chamber is rotated towards the currently active portion of the outlet prior to the powder being dispensed.

### TECHNICAL FIELD

The present invention relates to a beverage-making method.

### BACKGROUND ART

More specifically, the present invention relates to a method of making a beverage, in particular coffee, by means of a brewing assembly and from a powder ground inside a grinding device comprising two grinding units, and fed by a funnel directly into a brewing chamber mounted to oscillate about a horizontal axis.

To make a brewed beverage, the two grinding units are normally used to feed the brewing chamber selectively with powders of different characteristics; and the funnel normally comprises a central cup having two inlets at the top, each connected to a respective grinding unit, and one vertical outflow conduit at the bottom, with one outlet. Alternatively, the central cup, the outflow conduit, and the outlet are divided by a central vertical partition into two separate parts, each communicating with a respective inlet.

When preparing brewed beverages in accordance with the known art, the powder is loaded into the brewing chamber by setting the brewing chamber to a given, normally vertical, loading position, in which an inlet of the brewing chamber is positioned directly beneath the funnel outlet.

This method has several drawbacks, on account of the arrangement of the powder inside the brewing chamber, and therefore the characteristics of the resulting beverage, varying according to the type of funnel and which of the two grinding units is used.

To eliminate this drawback, it has been proposed to insert additional baffle devices between the grinding units and the brewing chamber, to correct the fall path of the powder as required.

Though successful in achieving an optimum arrangement of the powder inside the brewing chamber, the above solution seriously complicates the design, and so increases the manufacturing cost, of the brewing assembly.

### DISCLOSURE OF INVENTION

It is an object of the present invention to provide a method of making a beverage using a brewing assembly, which method is designed to achieve an optimum arrangement of the powder inside the brewing chamber of the brewing assembly, without complicating the design of the brewing assembly.

According to the present invention, there is provided a beverage-making method as claimed in claim 1 and preferably in any one of the following Claims depending directly or indirectly on claim 1.

### BRIEF DESCRIPTION OF THE DRAWINGS

A number of non-limiting embodiments of the invention will be described by way of example with reference to the accompanying drawings, in which:

FIGS. 1 and 2 show axial sections of a first preferred embodiment of a brewing assembly implementing the method according to the present invention and in respective operating positions;

FIGS. 3 and 4 show axial sections of a second preferred embodiment of a brewing assembly implementing the method according to the present invention and in respective operating positions.

### BEST MODE FOR CARRYING OUT THE INVENTION

Number 1 in the attached drawings indicates as a whole a brewing assembly comprising a brewing device 2 located beneath a grinding device 3—in the example shown, a device for grinding coffee beans (not shown) into coffee powder for supply to brewing device 2 to make a coffee beverage.

Brewing device 2 is a known type comprising a cup-shaped body 4 having a longitudinal axis 5 and mounted to oscillate about a horizontal axis 6 under the control of an actuating device 7, which comprises a motor 8, and a transmission 9 connecting motor 8 to cup-shaped body 4.

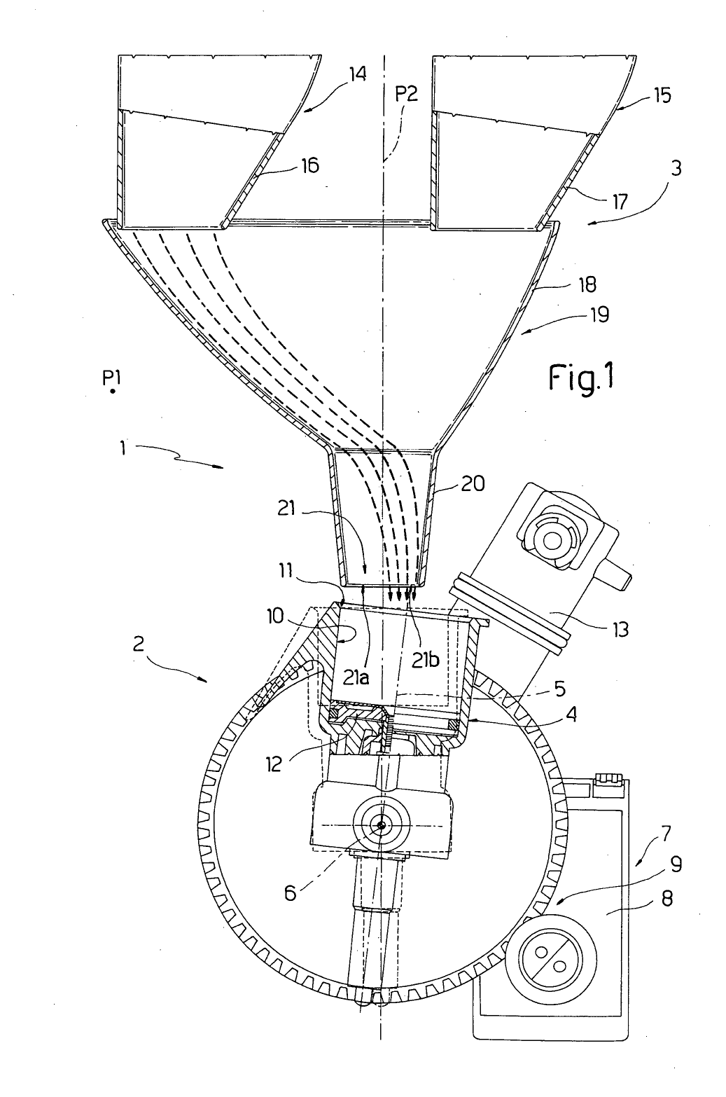

Axis 6 is perpendicular to a plane P1 coincident with the plane of each of FIGS. 1 to 4, and lies in a vertical plane P2; and cup-shaped body 4 is positioned with its concavity facing upwards, and defines a brewing chamber 10 communicating externally at the top through an inlet 11. Brewing chamber 10 houses an ejector piston 12, which is normally positioned at the bottom of brewing chamber 10, and is movable, by a known control device not shown, towards inlet 11 to expel the powder dregs from brewing chamber 10.

Brewing device 2 also comprises a pressure piston 13 located radially with respect to axis 6, and which is moved axially in known manner to engage inlet 11 when cup-shaped body 4 is moved about axis 6 into a brewing position, in which cup-shaped body 4 is coaxial with pressure piston 13.

The grinding device 3 employed comprises two grinding units 14, 15, which are located side by side in plane P1 and on opposite sides of plane P2, and have respective outflow conduits 16, 17 converging downwards towards plane P2 and connected integrally to a top edge of a cup 18 of a funnel 19. A substantially vertical outflow conduit 20 extends vertically downwards from cup 18 towards brewing device 2, has an axis coincident with the intersection of planes P1 and P2, and has an outlet 21 divided by plane P2 into two portions 21a, 21b, of which portion 21a is located on the same side of plane P2 as outflow conduit 16.

In actual use, grinding unit 14, when activated, dispenses a stream of powdered coffee which flows down cup 18 and, as it enters outflow conduit 20, tends to flow through plane P2 and out through portion 21b of outlet 21. This therefore makes portion 21b the “active portion” of outlet 21 as regards grinding unit 14, and, by the same principle, makes portion 21a the “active portion” of outlet 21 as regards grinding unit 15.

When brewing assembly 1 is set to make a coffee (or other brewed beverage), brewing device 2 is normally set to a standby position with longitudinal axis 5 of cup-shaped body 4 coincident with the intersection of planes P1 and P2, and either one of grinding units 14, 15 is activated to produce powdered coffee for supply to brewing chamber 10.

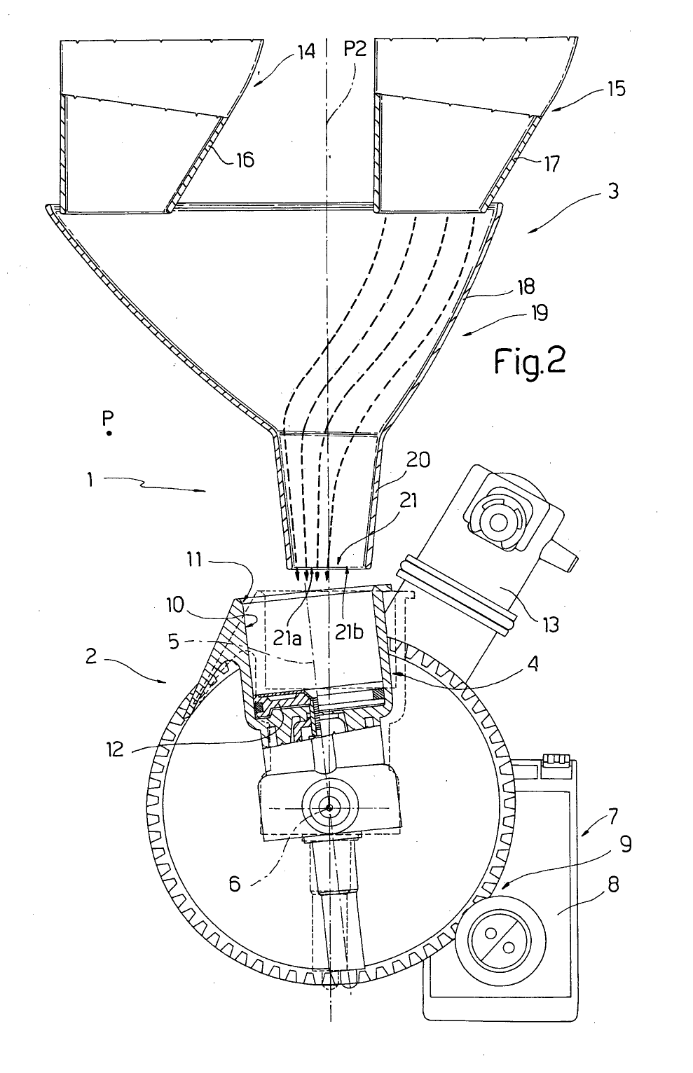

The grinding unit used can be selected on the basis of several criteria, but is normally a question of user choice if the two grinding units contain coffee beans of different types and/or grind the beans differently. Whichever the case, once the choice is made, actuating device 7 is operated to rotate cup-shaped body 4 about axis 6 towards active portion 21b (FIG. 1) or 21a (FIG. 2) of the chosen grinding unit 14 or 15. The degree of rotation is preferably such as to keep outlet directly and completely over inlet 11 of brewing chamber 10.

The powder flow, which would otherwise hit the lateral surface, and accumulate to one side, of brewing chamber 10, thus drops straight to the bottom and is distributed more evenly inside brewing chamber 10.

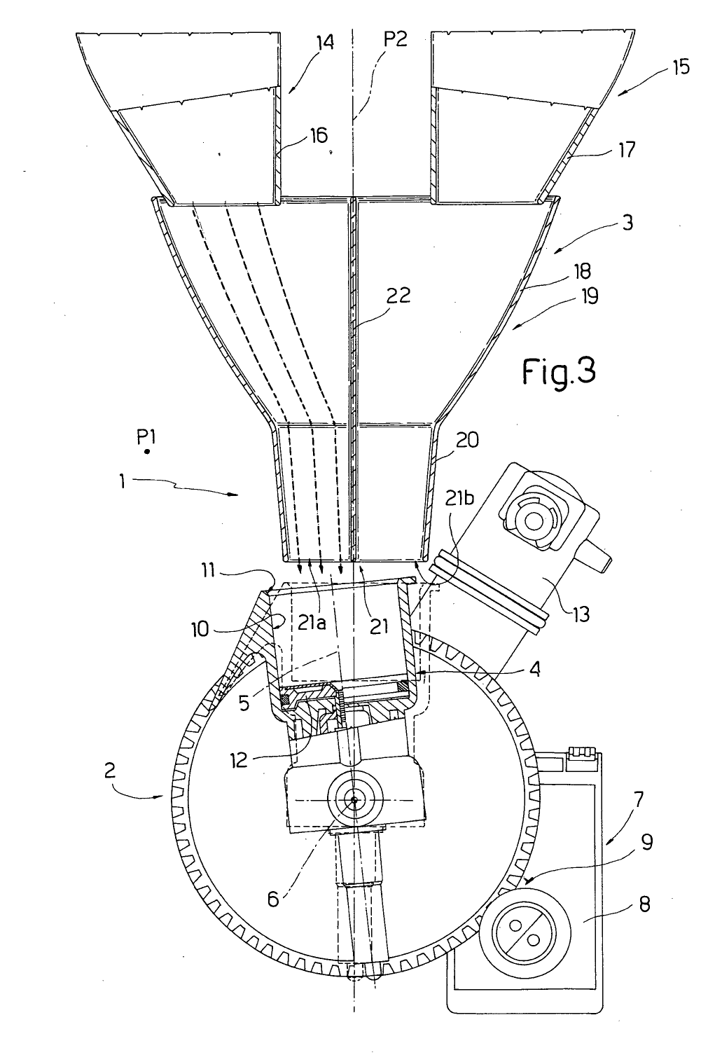

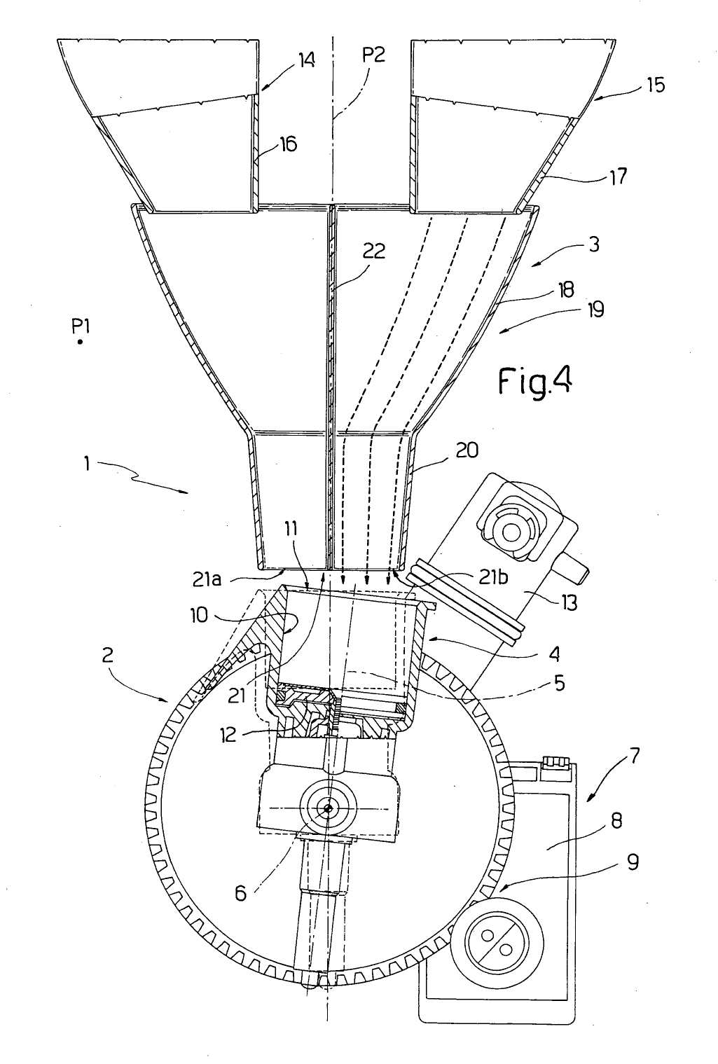

In the FIGS. 3 and 4 variation, portions 21a and 21b are physically defined by a partition 22 lying in plane P2 and extending the full height of funnel 19. In which case, since the powder can no longer flow through plane P2, portion 21a is the “active portion” of outlet as regards grinding unit 14, and portion 21b the “active portion” of outlet 21 as regards grinding unit 15, so inlet 11 of cup-shaped body 4 is moved towards portion 21a when activating grinding unit 14, and towards portion 21b when activating grinding unit 15.

In both the embodiments shown, cup-shaped body 4 is moved by rotating it about axis 6, but the same result may obviously be achieved by not rotating cup-shaped body 4 at all, and by moving the whole of brewing device 2 in either direction parallel to plane P1.

1. A beverage-making method for making coffee, the method comprising:
providing a brewing assembly, wherein the brewing assembly includes a brewing chamber having an inlet located beneath and generally facing an outlet of a funnel of a grinding device having a number of grinding units; and
selectively activating one of the number of grinding units to feed a powder to the brewing chamber through a corresponding active portion of a number of active portions of the outlet;
imparting to the brewing chamber, prior to the powder being dispensed by one of the number of grinding units, a given rotation about a substantially horizontal axis of rotation towards a corresponding one of the active portions of the outlet.

2. The method as claimed in claim 1, further comprising employing two grinding units located side by side in a first vertical plane and on opposite sides of a second vertical plane substantially perpendicular to the first plane and dividing the outlet into two portions, each of which is the active portion of a respective one of the number of grinding units; the rotation being a rotation in the first plane.

3. (canceled)

4. The method as claimed in claim 2, wherein the axis of rotation lies in the second plane.

5. The method as claimed in claim 2, wherein each of the number of grinding units and the relative active portion of the outlet are located on opposite sides of the second plane.

6. The method as claimed in claim 2, wherein the funnel comprises a central partition lying in the second plane; each of the number of grinding units and the relative active portion of the outlet being located on the same side of the second plane.

7. The method as claimed in claim 1, wherein the rotation imparted to the brewing chamber is of such an extent as to keep the outlet directly and completely over the inlet of the brewing chamber.

8. A method of making coffee, comprising:
providing a brewing assembly including a brewing chamber having an inlet located beneath and generally facing an outlet of a funnel of a grinding device having a number of grinding units; and
selectively activating one of the number of grinding units to feed a powder into the brewing chamber through a corresponding active portion of a number of active portions of the outlet;
prior to the powder being dispensed by one of the number of grinding units, imparting a rotation to the brewing chamber about a substantially horizontal rotation axis towards a corresponding one of the number of active portions of the outlet.
